(19) United States
(12) Patent Application Publication
(10) Pub. No.: US 2007/0197877 A1
(43) Pub. Date: Aug. 23, 2007

(54) Behavior Based Multi-Agent Systems As Data Types

(76) Inventors: Stefaan Decorte, Brussels (BE); Filip Verhaeghe, Ieper (BE)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/597,832

(22) PCT Filed: Jan. 5, 2005
(86) PCT No.: PCT/EP05/50028

§ 371 Date: Aug. 9, 2006

Related U.S. Application Data
(60) Provisional application No. 60/534,294, filed on Jan. 5, 2004.

(51) Int. Cl. G06F 19/00

(52) U.S. Cl. 600/300; 705/3

(57) ABSTRACT

The embodiments of the invention include a computer-readable medium having computer-executable components comprising at least one agent having at least one sensor component, having a goal or change method component, and at least one behavior component. The at least one sensor component generates at least one event based at least in part on at least one generated value from the goal or change method component. The at least one behavior component determines whether to activate a thread of execution based at least in part on the at least one generated event from the at least one sensor component. The system complex execution threads can be generated by any operator on agents level, events level, sensors level and behaviors level.

### TECHNICAL FIELD

The invention generally relates to computer programming languages and, more specifically to systems and methods for implementing behavior based multi-agent computing systems.

### BRIEF DESCRIPTION OF DRAWINGS

A more complete appreciation of embodiments of the invention will be readily obtained by reference to the following detailed description when considered in conjunction with the accompanying drawings, wherein

FIG. 1 is an overview block diagram illustrating the various of components of an RIDL agent according to embodiments of the invention.

FIG. 2 is a table illustrating where overridding is accepted in RIDL according to embodiments of the invention.

### DISCLOSURE OF SEVERAL EMBODIMENTS

Embodiments of the invention include apparatuses and embodiments of several methods of implementing a behavior based multi-agent system as a data type.

Specific programming language concepts are described herein with reference to a specific language implementation, termed RIDL (Robot-Intelligence Definition Language). It should be appreciated, however, that other implementations using the various concepts and aspects as described herein may be implemented without departing from the invention.

RIDL is a robot programming language suitable for hardware or software (virtual) robot programming that, in one aspect, adds several keywords over traditional languages. For example, RIDL may be a superset of Java, AGENT# as a superset of C#, DOTNET and C++, however, it should be understood that other language constructs may be used besides C#, DOTNET, C++ and Java. Hence, RIDL as described herein includes an abstract description of the various concepts, principles and methods that drive the RIDL application family.

As will be described herein, the language, methodology and implementation of RIDL will be described with reference to a compiler, however, it is understood that the invention is not limited to compilation, and the invention is also not limited to the particular syntax and implementations as described herein. For example, aspects of the invention may be implemented using an interpreter or other language reading engine.

COMPILER LEVEL ASPECTS

Agents as Data Types

In the various embodiments, added keywords make the creation of multi-agent systems very straightforward. For example, a keyword “agent” is added at the same level as a traditional “object.” For the purposes herein, the keywords agent and object are interchangeable from syntactical point of view. The effect of the keyword indicates that the block defines an agent. One skilled in the art will notice that other words than “agent” could be used. It would also be possible to annotate the object with attributes that indicate that such an object is in fact an agent. Whatever the syntax, the objective is to indicate that what is enclosed is an agent, and behaves as such.

According to one aspect of the invention, agents are considered as a native data type, exactly like objects. All actions that can be done with objects can also be done with agents. Examples of such actions are creation of new agents, destruction of agents, passing agents as parameters, creating references (pointers) to agents, duplicating agents, etc.

Like with objects, agent definitions actually define classes of agents. For example, an agent instance is created by a new statement, or when a new variable of that type (an agent class) is defined.

Ultimately, a language may be defined in which all objects are by definition agents, and hence one would not need to designate objects as being agents. The compiler may distinguish between active agents (agents) and passive agents (objects) by determining if the featurcs decribed below are used (sensors and/or behaviors). Therefore, agents as a data type can only be completely understood by taking the various features described below into account.

Sensors

A sensor defines the external or internal signals an agent will react on. A sensor as used herein is a variable of traditional type that is annotated as a sensor. This annotation can be done by adding an attribute to the variable, or by using a new keyword to indicate that a special variable is defined. In one example, the attribute “sensor” may be used to annotate an existing variable.

A sensor is a part of a multi-agent system. In one embodiment, a sensor 104 is part of a specific agent, however, a sensor may also be defined as “global”, wherein it isn't part of any particular agent but available to all agents (and hence it cannot “die” as agents can ). When a sensor is updated or changed, it throws an event to indicate what has happened. There are two events associated with a sensor: the updates event and the changes event. A sensor works as follows: everytime it receives a new value it throws an updates event. If the new value is different from the previous value, also a changes event is thrown. These events can be received by the behaviors (described below).

At this time, the languages C# and C++ already have an annotation that allows a variable to throw events when something happens to the variable. However, to receive this event, the listener must register onto the throwing variable. In contrast, according to one aspect of the invention, the listener does not need to register to receive an event. For example, “behaviors” 104 may listen for types of events, and any event that fits the type will be picked up by the behaviors 106. Therefore, the invention contrasts with previous multi-agent systems where the number of agents is dynamic and a behavior does not necessarily know which agents are present. In such case, a behavior cannot register onto these agents. This functionality will be discussed in further detail when the any operators are discussed.

To use a descriptive metaphor: suppose you are having a telephone conversation. In C# and C++, a user can talk to anyone the user knows is at the other end of line. However, if somebody on the other end says something and the user did not know beforehand that the other individual was going to be present, th e user will not hear the other individual. In RIDL, a user will hear everyone who is speaking on the other side, and a user can converse with all of them, even if the user did not expect the other individual to be there or if the user was not informed of the presence of the other individual beforehand. Therefore, this aspect accounts for uncertainty within the environment, and with continuous changing populations of agents and changing environments.

In C# and C++ and related programming languages, a program mer explicitly needs to throw an event. The programmer has to write code to call a method on the event, in order to notify listeners (e.g. “throwEvent(myEvent)”). In the various aspects of the invention, however, the listener may decide whether an event is recorded.

Behaviors

A behavior is active, which means it has its own thread of cxecution. Behaviors run concurrently from the programmer's point of view. A behavior doesn't return values, but rather defines some action to be taken when specific events occur. It defines what to do in response to external or internal events. Behaviors are always void, and can not take any argument. They implement reactional intelligence by activating on well defined combinations of events and agent states.

While goals and sensors can be visible outside the agent, behaviors are always private or protected. Only protected behaviors can be overridden, and their visibility (protected or private) must be persistent through all child agents.

A behavior is a method (a procedure that is part of an object, or in the invention, that is part of an agent) that is annotated as a behavior. This annotation can be done by adding an attribute to a method, or by using a new keyword to indicate that a special method is defined. As such, in one example, a new keyword “behavior” is used to indicate such a special method.

Behaviors have their own events. For example, every time a behavior is started, it throws an activates event, and upon completion, it throws a completes event. Other events may be defined, and the names of the events indicated here are for clarification only, as the exact syntax may vary. Examples of other potential events are suspended, born, died, waiting, etc. Any number of events can be implemented. In one aspect, events may provide information to other behaviors and other agents about its status. In one embodiment, a behavior will throw these events without any action on the part of the developer.

In one embodiment, behaviors may differ from traditional methods in the way they are activated. For example, traditional methods, as they are defined in object-oriented methodologies, are invoked by some other method. A method may potentially be invoked as part of the creation of a new thread of execution, but even in this case, it is some external logic that determines when the method is called. In contrast, behaviors may be completely in control over when they are activated. In one embodiment, behaviors may not be invoked by external logic and only they themselves may decide when to activate. As such, these behaviors 106 do not need external code to become active.

A behavior may have a section that indicates when it is should be activated. For example, this section may contain a triggering condition. The triggering condition is typically separated from the code to execute, although it doesn't have to be. However, in the various embodiments the triggering condition is part of the specification of the behavior.

As mentioned above, it is important to note that the triggering condition is local to the behavior. The code to be executed, and the conditions that cause it to execute, are brought together in the same place. This makes it possible to reason about the behavior of the system in isolation. When describing the actions of the agent, one can describe its behavior based on its local perceptions of the world, without knowing what causes these perceptions and who is causing them. The agent just responds to the forces around it, which, for example, is a natural model for many large scale problems in economics, computer science, finance, business, social sciences and many other fields.

In one embodiment, a triggering condition uses the events thrown by sensors and behaviors to drive its activation. A triggering condition conceptually includes two parts: a “when” part that indicates events to which it responds, and an “if” part that is based on values and other parameters to filter the events. Other languages, such as Visual Basic, C# and C+ and Java, allow for throwing and catching singular events. However, In RIDL, for example, it is possible to use multiple events and complex conditions to select which events the behavior wishes to catch. In essence, the behavior applies some real-time form of querying on the events.

It is possible to define a triggering condition based on known agents. Since agents, like objects, are data types, it is possible to refer to them through the name of the variable that holds them (if held in a variable), or by reference (pointer). As a result, triggering conditions can be defined staticly.

Various embodiments can be characterized by waiting for a specific event. First, that means that one needs to specify which sensor or behavior we mean within the agent. Next, one needs to define which type of event they are waiting for to take place. For example, a natural model is to indicate the agent one is waiting for, followed by a dot, then name the sensor, followed by a dot, and then name the event. For instance “MyAgent.MySensor.updates” would be a natural model. However, the syntax could take any shape or form. The point is that one indicates the agent, then the sensor/behavior, and finally the event.

In the “when” part of the triggering condition, events can be concatenated with “or” keywords, or by something with a similar meaning. This allows one to create a list of events that they want the behavior to be sensitive to.

In the “if” part of the triggering condition, all normal programming operators can be used, including boolean operators. In the “if” part, all variables and operators that one could use in body of the behavior/method, are available. For instance, every variable within a scope can be used, where the scope is defined as in traditional languages like Java and C# and C++.

Goals

Goals implement requests made to an agent. A goal is not an active object and it contains no data. As a direct consequence, goals have no events associated with them. Goals can be called with multiple parameters and these parameters can be of complex datatypes. When they are called, they pass their data to the (passive) datamembers and member sensors. Therefore, they can be regarded as the interface or communication channel of the agent. Goals are different from normal methods (like on objects) because they express a request to the agent, on which the agent can decide to react or not.

Goals also have a return type, like any other normal method. Because sensors can only be set from within goals, and not from within usual methods, methods are regarded as some kind of a guaranteed execution while goals perform a request, whose result can be different with each invocation. Requests are not guaranteed to be taken into account, but depending on the reasoning and state of the agent, they can lead to different agent actions. After all, an agent can have much more important work to do, like a robot balancing over an edge will never pay attention to bird sounds captured by his sound sensor.

Goals are the only places in which it is allowed to change the value of a sensor. Because they represent requests to agents, they translate their request into sensor changes, on which the active parts of the agent can react. A method can be used to read the state of an agent, or to accomplish something directly, actively. Goals only have ‘side-effects’, they conceptualize requests to an agent on which he can possibly react. As such, goals are only available on agents, and not on objects which are always passive. If you call a method, you also know that the agent will never ‘know’ it.

Goals arc declared syntactically in the same way like normal methods. They receive however the “goal” qualifier to indicate that one deals with an agent request.

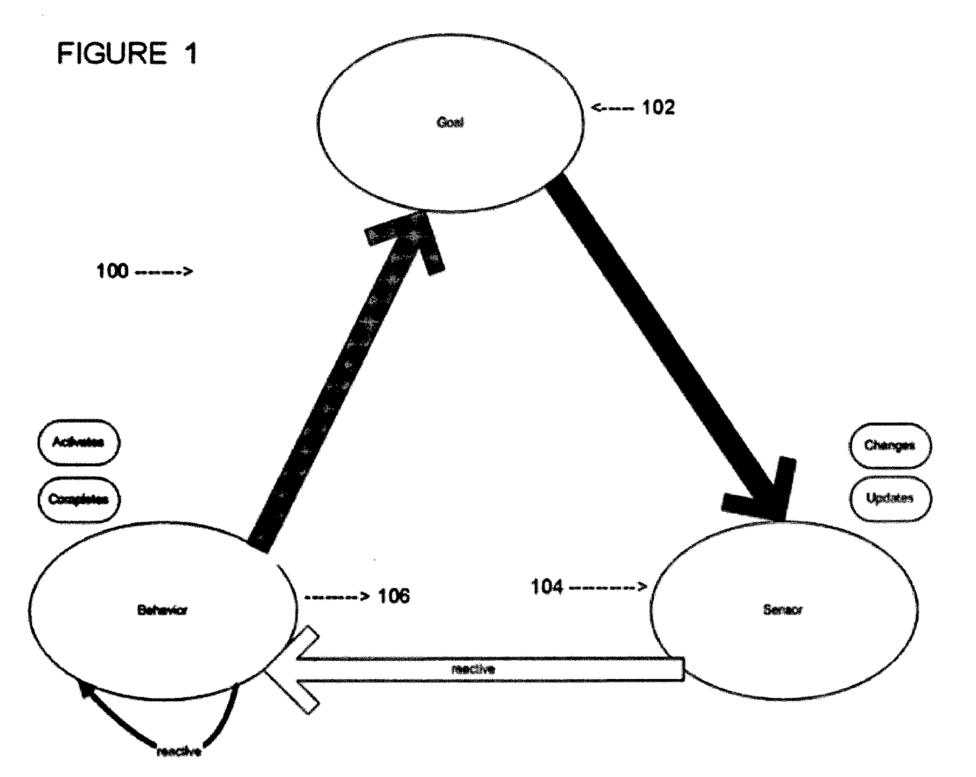

FIG. 1 clarifies the relation between the different RIDL agent 100 constructs, the events they throw, and where they are handled. Goals 102 have write access to sensors 104 (in the same agent only), sensors 104 react on new values by throwing changes or updates events, which are handled by behaviors 106, which on their turn throw activates and completes events. These events are finally caught by other behaviors (not shown). All behaviors 106 try to effect changes by calling their own agent goals 102 or the goals in other agents.

Any Event Operators

The explicit indication of the event we are waiting for is often not flexible enough. For example, when the developer wants to wait for multiple events. One solution is to exhaustively specify all possibilities, but in combination with other operators such as those defined below. This can be very tedious (and sometimes even impossible due to lack of information). As such, in one embodiment, the invention includes a generic event. The idea is that one may be waiting for any event coming from the named agent's sensor 104 or behavior 106. For example, one way of writing this is to omit the event name or to use the name “event” for the generic event Alternatively, many other notations may be conceived. For example, the notations “MyAgent.MySensor” or “MyAgent.MySensor.event” would respond to both changes and updates events.

Any Sensor/behavior Operators

In one senario, the agent's structure is totally unknown and it is not known which behaviors 106 or sensors 104 are inside the agent. It may still be that one wishes to be informed about any activity within any behavior 106 or sensor 104 of the agent. To this end, in one embodiment keywords such as “sensor” and “behavior”, replace the indication of a specific sensor 104 or behavior 106. Again, other syntaxes can be used, but the point is that a stub is used instead of the explicit name of the sensor 104 or behavior 106. For example, a possible way of writing this is “MyAgent.sensor.changes”. This agent will wait until any sensor in the agent MyAgent changes its values (it will ignore updates that do not change the value). One skilled in the art will notice that again the developer has the choice of specifying the event, or to use the generic event indication (as defined in the previous paragraph). In the same vein, agents can replace the name of an explicit behavior with a stub that indicates we are waiting for any behavior. For instance, “MyAgent.behavior.activates” would mean that one is waiting for any behavior within agent MyAgent to activate, which would effectively allow one to monitor if the agent is active without having to know which behaviors are defined.

The ability to stub the names of sensors 104 and behaviors 106 may allow for agent applications that can deal with other agents that were not defined at the time of writing of the first agent. The new construct works fine in the “when” part of the triggering condition. However, in reference to the “if” part of the condition, it may well be that one wishes to respond to any sensor that, for example, has a value higher than 100. In such an example, because the name of the sensor 104 is stubbed, the “if” part is at a loss on which sensor it should test to see if its is over 100. As such, what the “if” part needs is to know which sensor 104 of the agent threw the event. Therefore, in one embodiment, the “when” clause may include annotation of the sensor 104 with the name of a variable. This variable will store a reference to the sensor 104 that threw the event. Because the “if” part is evaluated after the “when” part, the “if” part can use this variable to identify the sensor 104, and to investigate its properties (such as its value).

Within the body of the behavior 106 that was activated by the triggering condition, the variable from the “when” part can also be used. Therefore, the behavior 106 can target its response to the event-throwing sensor 104, if needed. This is particularly powerful in combination with introspection attributes.

Any Agent Operators

In another example, a behavior 106 may wish to respond to events coming from any agent, including agents that join the agent society at any point in time after the behavior 106 started to wait for its triggering conditions. Indeed, even while the behavior 106 is passive and idle, and without any code on the developers side, the behavior 106 may wish to be aware of every agent in the system, including new joiners and agents that leave the system.

One skilled in the art will notice that this problem is fundamentally different from the previous problems. An agent is defined at design time, and hence an agent class cannot change its definition at runtime. As a result, at compile time, an agent always knows the list of its own behaviors 106 and sensors 104. Previously, since there was no operator at the agent level, one always knew what agent they were talking about. Hence, the any operators at the level of events, sensors and behaviors can be resolved by the compiler if all agents are compiled together (and since one does not use the any operator on agent, and hence always refers to a variable or pointer with a kown data type (agent), the compiler always knows).

The “any” operator at the agent level introduces a completely new level of complexity. If “any” operators on agent level are used, it is possible that agents may join the society that were unknown at compile time. This implies that the agent must now resolve their any operators at runtime. Various aspects that make it possible for RIDL agents to join societies coming from elsewhere are discussed in the section on “runtime level aspects” below.

In one embodiment, an agent may talk about agents that were initially unknown. For example, in the triggering condition of a behavior 106, instead of referring to a specific agent, one may refer to an agent class. As mentioned above, an agent is a data type and as such has a name. The instances of the data type may or may not have names (variables versus dynamic memory allocation). So, by using the name of the agent data type (the name that is used in the agent definition), all agents in the class can be indicated. When a triggering condition uses the class name of the agent, it actually means that it waits for a specific event from any agent that is member of that agent class.

Again, while this works for the conceptual “when” part of the triggering condition, it may present a problem for the “if” part, and also for the execution of the code. When one picks up an event, then they may want to check if the agent that sent the event conforms to specific conditions (the “if” part of the triggering condition). Therefore, when they receive an event, they also need to capture a reference to the agent that sent the event.

In one embodiment, the agent class may be annotated with a variable name. For example, this variable will store a reference to the agent that caused the event. Through this reference, one may access all public properties of the agent, including the values of public sensors. All actions normal on agent references can be done on these generated references.

In another embodiment, one may want to be able to interact with previously unknown agents. To this purpose, in one embodiment, references (pointers) may be included for a generic type agent. For example, agents may be defined with this generic reference type. For example a call for an “Agentsensor.event” will respond to any event of any sensor from any agent. One skilled in the art will notice that again different syntactical notations are possible.

Agent Level Events and Operators

So far, it has been have assumed that only sensors 104 and behaviors 106 may throw events. However, in various embodiments agents themselves may also throw events. In particular, events that indicate that they are born, are dying, are joining the community (but were born elsewhere) or leaving the group (but not dying). This allows agents to respond even more targeted to each others actions. In one embodiment, “welcoming committees” can respond to agents joining, to inform them of the rules of the community, for instance.

Agent level events may be associated with any agent operator. For example, one possible notation is “<NewMember:>MyAgentjoins”, which waits for any agent of the class MyAgent to join the group, and assigns a reference to that new agent to the variable NewMember. This is just a syntactical example, and the same effect may be obtained through completely different notations. Another example is “<NewBorn:>Agentborn”, which will respond to any agent of any type that is newly created within the community. Communities will be discussed in further detail below in reference to service level aspects.

Subsume/resume

Intelligent systems are often created in layers, where higher layers interact with lower layers and override lower layers. Nevertheless, the lower layers typically remain active. Only limited functionality is overridden, while the bulk of the actions remain intact. Rather than removing the entire agent and replacing it by another, the invention allows for subsuming specific behaviors. Subsumption means that one behavior pauses another behavior, and takes over control. This is typically done to handle exceptions to the defined behavioral rules. After the exception is handled, the control is resumed to the subsumed behavior through the resume statement.

Subsuming and resuming are runtime features. They can be used on any behavior 106. For instance, if an agent is stored in a variable “MyAgent”, one can directly specify the behavior with the name “MyBehavior” through “MyAgent.MyBehavior.subsume”. Again, other syntaxes may achieve the same effect.

A behavior 106 can be subsumed by any behavior, including itself. In one embodiment, a subsumed behavior can be resumed from any other behavior (hence not by itself, since it is inactive). The behavior 106 that does the subsuming need not be the same as the behavior that does the resuming.

In one embodiment, every behavior 106 has a predefined property called “subsumed” (or some equivalent name). Although the property is part of the behavior 106, it is a sensor 104. For example, such a sensor 104 may be a scalar sensor (for instance “int” or “integer”). In one embodiment, the property counts the number of times a sensor is subsumed. If a behavior is not subsumed, its subsumed property will be zero. Every time the behavior receives a subsume request, a counter will be increased by one. Every time the behavior receives a resume request, it will decrease its counter. The behavior will work if the subsumed property is zero. A subsumed behavior completes upon subsumption. This means that upon resumption, it will re-evaluate its triggering condition. This implies that the behavior first looks at its environment when it is reactivated. This functionality may prevent it from performing incorrect actions.

One skilled in the art will notice that the subsumed property is a true sensor. Hence, when it changes, it throws an event. The subsumption status can be used in triggering conditions. In combination with a “completewhen” statement (described below), this also allows a behavior 106 to monitor its own subsumption status. Using this construct, a behavior 106 can execute code just before it is subsumed, ensuring that no damage is caused because the behavior is interrupted in the middle of its body.

Because the features described above are runtime features, they can also be utilized for agents of which one only has reference. Hence, these features may be invoked in the body of behaviors, who select other behaviors with “any” operators.

The features on subsumption and resumption have been described as syntactic keywords. However, these features may also be offered as methods that are by default available on the agent. For example, for an agent “shopAgent,” if one wants to subsume its “buyBehavior,” one could write “shopAgent.subsume(“buyBehavior”)” if the functionality was implemented as a method on the agent. If subsume were a keyword, the same would be written along the lines of “subsume shopAgent.buyBehavior”. As such, whatever the way of writing, the concept remains the same.

Inheritance

One of the key features of object-orientation is the capability to create derived types. An object's functionality can be refined by inheriting all of the functionality, and overriding functionality as needed. The invention may be utilized to do the same with agents. When an agent is refined, one can do exactly the same as with objects. Methods can be overridden to be refined.

In one embodiment, behaviors cannot be invoked by other code, because they decide themselves when they are activated. As such, behaviors have no parameters. When behaviors are overridden, they are immediately replaced by new behaviors.

Sensors are a type of variable. Hence, normal scope rules apply. This implies that sensors may replace sensors with the same name.

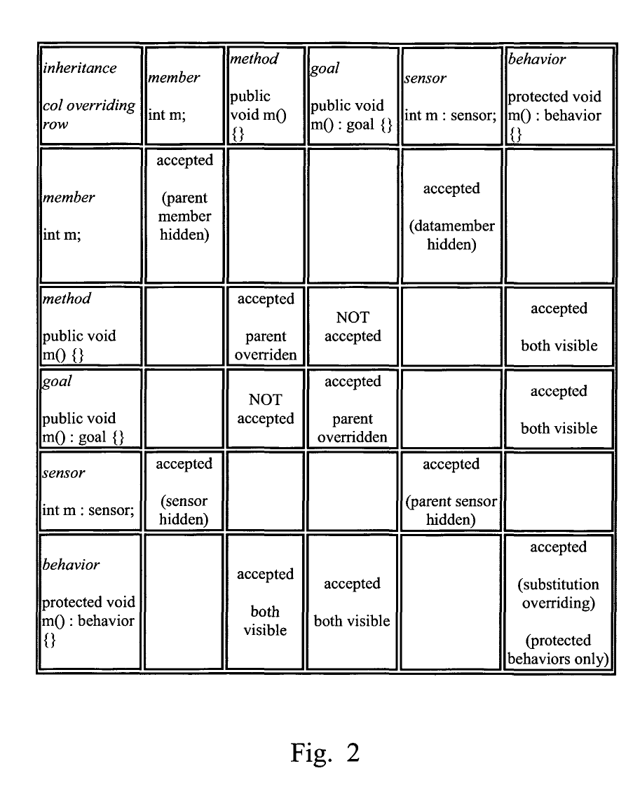

Most importantly, the event mechanism remains intact upon inheritance. When an agent is inheriting a behavior, the triggering condition of this behavior will take into account that it needs to look at the behaviors in the child agent. If no behaviors are present in the child, it will look for these behaviors in the parent agent. In combination with the any sensor/behavior operator, this allows agents to perform relatively complex logic, where the parent can provide functionality without explicitly knowing the structure of the child agent, or its other capabilities. FIG. 2 illustrates one embodiment of where overriding may be accepted in RIDL.

Agent Any Operator Revisited

In the definition of the agent “any” operator, one may specify a name of a class. If the “any” class specifies the name of a class that has children, all of its offspring will also be considered by the “any” operator. As such, the child of an agent is an agent of the same class, with refinements.

If the name of a child agent is used in the any operator, then the parent agent will not be part of the any operator. A parent is not part of the class of the Child Agent. For example, if a car is a child agent of a vehicle, any vehicle will include cars, however, “any” car will not include every vehicle.

The fact that “any” operators are inheritance-aware makes them suitable for complex decision making. For example, an agent could activate a behavior 106 on the following conditions: if any ship is approaching, and there are no military ships in the neighborhood, then activate behavior. In another example, if a teacher does not have a classroom, and no classrooms are available, then the agent may activate a behavior. One skilled in the art will notice that sensors can themselves be agents, since sensors are variables, and agents are data types. Also, agents can be passed as parameters to methods.

Splitting Events from Behaviors (Event Handling Constructs)/Changing Triggering Conditions

The sections above discuss behaviors that have triggering conditions. It is also possible to create a language construct that responds to triggering conditions, and that either throws a specific event, or that directly invokes a method. Such a construct in one aspect essentially splits triggering conditions from the method/behavior. Similarly, triggering conditions could mingle the when and if part.

Service Level Aspects

As the integration of software gets ever harder, and software gets ever more complex, the way software is being designed is changing. Recently, there has been a trend toward service-oriented software engineering. The essence of this approach is that a software application has an interface based on standards, such as XML Web Services. The software offers its functionality as a service through this interface. Integrating different software packages becomes a mere matter of gluing the services together.

In software engineering, namespaces are used to group together objects into logical assemblies. A “disk” namespace could contain all routines that interface with the disk, for instance. According to one aspect of the invention, namespaces are used to bring together agents in a similar way as objects are brought together. In particular, agents can be part of the namespace, and can share a namespace with objects. In other words, in this aspect the language doesn't distinguish between agents and objects, as they both follow the same rules.

At the level of namespaces, one embodiment of the invention includes a “service.” Services at the language level are similar to namespaces, in that they bring together objects and agents with similar functionality. In particular, it brings together agents and objects that jointly achieve a single service. In various embodiments, a namespace can be indicated to be a service by using a new keyword, by using an attribute that annotates the namespace, or by assuming that every namespace that contains an agent is a service.

If a namespace is a service, it offers functionality. The functionality can be accessed through a defined interface. In various embodiments, the invention provides ways of specifying this interface.

In a first embodiment, a method is included to explicitly define an object or agent to be the interface to the service. For example, this can be done by providing an attribute to the object or agent.

In a another embodiment, a method is included to name the object or agent identical to the name of the service. In this case, the public variables and methods are the actual interface of the service. The agent or object of this class will be instantiated automatically when the service is started, and only one instance of this agent or object can be created per service.

Agent Oriented Database Level Aspects

One approach to agent-oriented databases (AODB) is to consider every record (object in an OODB) as a special kind of agent. The agent contains only sensors (no behaviors), and inheritance on these agents is forbidden. Every externally field, and every calculated or otherwise obtained field, is considered to be a sensor. Hence, a database is a set of agents that have only sensors.

This approach monitors what happens to the fields of every record. Every time a field is updated, an updated event (of the type that is used by a behavior's triggering condition) is thrown. If a field changes value, a changes event is thrown. The result is that behaviors can be defined that monitor and respond to changes in the database. From a conceptual point of view, the database is filled with agents, to which other agents can respond.

Alternatively, a database agent could be just like any ordinary agent, with sensors and behaviors and other attributes. The difference between a database agent and an ordinary agent is that its sensors are stored in the database. In this case, the software designer conceptually works with full blown agents. The structure of the database and the structure of the agent system must sufficiently match. The advantage of this approach is that the designer has the complete freedom of the agent model. The compiler will create the tables needed to support the model. When using this approach, it is desirable to annotate an agent with a keyword to indicate that this agent is persistent. This allows the compiler to distinguish between persistent and non-persistent agents.

Runtime Level Aspects—Moment of Execution

The power of the event mechanism described in the compiler aspects is shown by the type of optimizations the compiler can do. These optimizations impact the runtime performance. They are here classified under runtime, but they require the compiler to take action to generate the necessary lists and other materials for the runtime engine.

In various embodiments, real-time optimized and speed-optimized execution are features of RIDL. As described above, a triggering condition is split into a “when” and an “if” part. The “when” part specifies the events that trigger the evaluation of the “if” part of the triggering condition. Since every event is linked to a previously defined behavior or sensor (and a fortiori previously defined agent), and since every behavior relies on these events in its triggering condition, a dependency graph can be drawn between behaviors, with sensors as leaves in the graph. Every time a sensor is updated or changed, or a behavior is activated or completed, the event propagates through the graph and sets flags of triggering conditions that need to be re-evaluated. The triggering conditions are evaluated and if they are met, then a flag is set to indicate that the behavior needs to be executed.

In one embodiment, there is a pool of execution threads that selects a flagged behavior, and executes it. For example, the pool of execution threads could be a single thread on the one extreme, or as many threads as there are behaviors at the other extreme. The number of execution threads may be dependent on the compiler execution, but could be decoupled from the number of agents and behaviors in the system. One skilled in the art will notice that “flagging” a behavior may take many forms. For example, it may include a variable set as a flag, the behavior (identification) could be added to a list and/or an execution thread dedicated to the behavior could start (which is equivalent to flagging and starting the execution at the same time).

Automatic Priority Detection for Behaviors

According to one aspect of the invention, behaviors that are lower in a hierarchy graph are given higher priority. Indeed, being lower in the hierarchy means that the behaviors are closer to the hardware or software interface. That means that they are closer to the events, and that they may be required to be more responsive.

An example in robots and machine control makes this clear. If a behavior is directly coupled to a hardware sensor, it is likely that very rapid response is needed. However, at the highest level, behaviors respond to sensors that were built by behaviors already responding to other RIDL sensors. In other words, the behaviors that are higher in the graph work with more abstracted data. Processing this information is usually less time sensitive than the low level behaviors (e.g., “reflexes” versus “thoughts”).

As before, an event of a sensor 104 or behavior 106 will propagate through a dependency graph, and will put the triggering conditions that need to be re-evaluated in a list. In one embodiment, a triggering condition processor will process this list. For example, the list may be priority-based, which means that every time a new behavior's triggering condition is added to the list, it may be sorted into the execution queue such that it is executed as soon as it has highest priority of all waiting behaviors. The priority reflects the distance to the leaves, where a leave has highest priority, and every additional dependency reduces the priority.

In smaller systems, it may be possible to evaluate the triggering condition immediately. In this case, every behavior automatically has highest priority, since no other behaviors are waiting given that the evaluation of triggering conditions is immediate.

If a triggering condition is met, the corresponding behavior is stored in a new list which contains the behaviors to execute. Again, this list may be sor ted by the priority of the behavior (with the same priority definition as above). The pool of threads may then execute the waiting behavior with the highest priority.

The net result is that lower level behaviors may execute multiple times before a higher 1 evel behavior that is dependent on them gets the chance to execute. This means that higher level behaviors may miss “frames,” where a frame is defined as an triggering condition that would have been true, had it been evaluated. This feature may be beneficial in that it assures prompt responses at the lowest level where prompt responses are needed. At the same time, it matches with the uncertainty principle that governs the actions of agents. An agent is never sure that what it believes to be true, is actually (still) true. As such, an agent is required to keep checking if it assumptions still hold. The net result of this uncertainty principle is that multi-agent systems are much more robust, because they are built from the ground up to handle anomalies.

A behavior 106 is often waiting for multiple events. In this case, the behavior 106 will always have a priority that is one lower than the event that just caused it to execute. Hence, the priority of a behavior changes dynamically at runtime.

An event of a sensor 104 has a priority that is one lower than the behavior 106 that updated the sensor and caused the event. In case the sensor 104 is updated from outside a behavior 106, it will be considered as a leave event, with the highest priority.

A behavior 106 that is triggered on system-defined events, such as timers, will be considered as leave behaviors and will have the highest priority.

In various other embodiments, there are additional rules that need to hold on all behaviors, and that impact the priority assigned. For example, a behavior 106 that is activated based on the completion of another behavior, may always be of lower priority than that other behavior. In another example, a behavior that is activated based on the activation of another behavior may have the same priority as that other behavior.

Exhaustive Behaviors

In various instances, the above hierarchical scheme may result in unintended priorities. In particular, there may be two graphs of dependencies inside the software. For example, one of the graphs may be responsible for executing data. The other graph may monitor the actions of the other graph. Because such graphs may start from the same sensors, and may not interact at the higher level the compiler may not be able to assign a higher priority to one graph or another. Instead, the complier may assign similar priorities to both, making them compete for resources at runtime.

One approach to this problem is to allow the user to explicitly define the priority of the behaviors. However, this approach may be error prone. Therefore, various embodiments of the invention include an “exhaustive” indicator. For example, when a behavior is marked as “exhaustive,” this may mean that the behavior is not allowed to miss any frame. For example, the behavior will respond with sufficient priority to ensure that it is executed before the next time its triggering condition becomes true. In various embodiments, exhaustiveness may not provide guarantees that the behavior is executed within a certain timeframe, however, it may guarantee that every time the triggering condition becomes true, it will be executed, and that the next execution will occur after the previous one has completed.

Further, an exhaustive behavior may be exhaustive relative to its own events. As such, its exhaustiveness may have no impact on other behaviors in the dependency list. In other words, it is not because a behavior is exhaustive, that another behavior that it is waiting for also becomes exhaustive or is in other ways changed in priority. As such, only behaviors explicitly marked as exhaustive are sure never to miss any frame. Of course, if another behavior relies solely on an exhaustive behavior, then it may be triggered more frequently than the normal behaviors, because a lot of events it is waiting for are generated.

Redundant Behaviors

Redundant behaviors are the opposite of exhaustive behaviors. When a behavior is marked as redundant, this means it has a lower priority than all normal behaviors. Like exhaustive behaviors, redundant behaviors do not change the priorities of other behaviors in any way. For example, only behaviors explicitly marked as redundant behaviors may have this lower priority. Of course, if another behavior relies solely on a redundant behavior, then it will never be triggered more frequently than the redundant behavior, because no events it is waiting for are generated.

Real-time Mapped Hierarchy Graphs

In support of real-time systems, behaviors are allowed to be explicitly mapped to specific numeric priority levels. For example, the developer may fix these behaviors and for every behavior where no numeric priority level is defined, the rules defined above may apply.

The continueWhen Statement

The “continueWhen” statement is a statement followed by a triggering condition. It is a statement that can be used at any point in the body of a behavior. For example, it may instruct the behavior to wait until a specified triggering condition becomes true. Such a statement is particularly useful if a behavior needs to execute a sequential series of actions. It may also provide a basic construct to ensure synchronization between behaviors. One example situation is when a robot needs to raise its arm (action) until it reaches a certain height (sensor). Then after it has done so successfully, it may need to push a button.

The continueWhen statement is a shorthand notation for functionality that may also be implemented using a state machine. For example, the behavior that contains the continueWhen statement can be split into several behaviors which use a state machine in combination with the specified triggering condition to have the same effect. In one embodiment, initially the state machine is in its state 0 and is waiting for a state 0 together with the triggering condition of the behavior. Upon completion of the first part of the behavior, it puts the state machine in state 1. A second behavior, which models the part after the continueWhen, waits for the state 1 together with the triggering condition specified in the continueWhen. When the last behavior in the state machine has been activated, the state is put back to 0.

In one aspect, the compiler may apply just this transformation to the software as shown, for example, by the code:

void MyBehavior( ) : behavior
when TrigCondWhen
if TrigCondIf
{

Statement1;
Statement2;
continueWhen TrigCondContinueWhen1

if TrigCondContinueIf1;

Statement3;
continueWhen TrigCondContinueWhen2

if TrigCondContinueIf2;

Statement4;

}
This can be transformed into:
int MyBehaviorState = 0;
void MyBehaviorPart0 ( ) : behavior
when MyBehaviorState.changes or TrigCondWhen
if (MyBehaviorState == 0) and TrigCondIf
{

Statement1;
Statement2;
MyBehaviorState = 1;

}
void MyBehaviorPart1 ( ) : behavior
when MyBehaviorState.changes or TrigCondContinueWhe n1
if (MyBehaviorState == 1) and TrigCondContinueIf1
{

Statement3;
MyBehaviorState = 2;

}
void MyBehaviorPart2 ( ) : behavior
when MyBehaviorState.changes or TrigCondContinueWhen2
if (MyBehaviorState == 2) and TrigCondContinueIf2
{

Statement4;
MyBehaviorState = 0;

}

The result is that the behavior includes a triggering condition and a method that is executed to its endpoint.

In one embodiment, the compiler may transform the continueWhen behavior into multiple behaviors, and may ensure that variables are accessible from both behaviors and not from anywhere else (since they are conceptually local). For example, It may achieve this by creating variables global within the agent, with unique names that are not referenced anywhere else in the agent.

CompleteWhen Statement

In the embodiments described above, the continueWhen statement is used within the body of a behavior. However, both the when and the completewhen statements are used outside the body of the behavior. As such, the “when” condition indicates when the body is executed. A “completeWhen” statement is the inverse of a “when” statement. It specifies a triggering condition upon which the behavior should stop executing. The completeWhen may again be followed by a body. In one embodiment, when the completeWhen is triggered, the body of the behavior is stopped, and the body after the completeWhen is executed. Within the body of the completeWhen, all local variables defined in the body of the behavior can be accessed. Conceptually, the code is inside the body and replaces all that remains to be executed. The completeWhen statement can be achieved by transforming the body of the behavior. For example, assume the following behavior:

void MyBehavior( ) : behavior
when TrigCondWhen
if TrigCondIf
{

Statement1;
Statement2;
Statement3;

}
completeWhen TrigCondCompleteWhen
if TrigCondCompleteIf
{

CStatement1;
CStatement2;

}

This can be converted into following code with the same effect:

bool MyBehaviorCompleteNow = false;
void MyBehaviorMustComplete( ) : exh austive behavior //&
highest priority
when TrigCondCompleteWhen
if TrigCondCompleteIf
{

MyBehaviorCompleteNow = true;

}

void MyBehavior( ) : behavior
when TrigCondWhen
if TrigCondIf
{

if not MyBehaviorMustComplete
{

Statement1;
if not MyBehaviorMustComplete

{
Statement2;
if not MyBehaviorMustComplete

{
Statement3;

}

}

}
if MyBehaviorMustComplete
{

CStatement1;
CStatement2;

}

}

In various embodiments, the check on the completion condition must have the highest priority, because no matter how high the priority of the behavior, the fact that it must complete has even higher priority. In one embodiment, an exhaustive keyword may be utilized in this instance because the check on the completion condition does not update a nything that triggers an event. For example, it updates a variable, not a sensor. As such, the compiler may convert the first code into the latter, and thereby implement the functionality. Alternatively, other means may be employed to inplement the required funcionality.

Whatever method is chosen, the compiler can transform a behavior with a completeWhen statement into a behavior without such a statement. As such, it is merely a very useful and powerful shorthand notation. The use of the statement is extremely frequent, especially in combination with the system-defined subsumed sensor of every behavior, as shown in the next example:

void MyBehavior( ) : behavior
when OtherSensor1.changes
{

Statement1;
Statement2;

}
completeWhen MyBehavior.subsumed.changes
if MyBehavior.subsumed
{

Clean_up_behavior;

}

In fact, the use of this statement is so frequent that it is allowed to use multiple completeWhen statements at the end of a behavior, to catch different events and take different actions. For example, if one wishes to take the same action on muitiple events, then one may make the triggering condition more elaborate.

After transformation, in one embodiment the compiler may generate code that uses if statements to execute the multiple completeWhen statements. In the example with the nested if statements:

void MyBehavior( ) : behavior
when TrigCondWhen
if TrigCondIf
{

Statement1;
Statement2;

Statement3;

}
completeWhen TrigCondCompleteWhen1
if TrigCondCompleteIf1
{

C1Statement1;
C1Statement2;

}
completeWhen TrigCondCompleteWhen2
if TrigCondCompleteIf2
{

C2Statement1;
C2Statement2;

}

This may be converted into following code with the same effect:

int MyBehaviorCompleteNow = 0;

void MyBehaviorMustComplete1( ) : exhaustive behavior (& highest
priority)
when TrigCondCompleteWhen1
if TrigCondCompleteIf1
{

MyBehaviorCompleteNow = 1;

}
void MyBehaviorMustComplete1( ) : exhaustive behavior (& highest
priority)
when TrigCondCompleteWhen2
if TrigCondCompleteIf2
{

MyBehaviorCompleteNow = 2;

}

void MyBehavior( ) : behavior
when TrigCondWhen
if TrigCondIf
{

if not MyBehaviorMustComplete
{

Statement1;
if not MyBehaviorMustComplete

{
Statement2;
if not MyBehaviorMustComplete
{

Statement3;

}

}

}
if MyBehaviorMustComplete == 1
{

C1Statement1;
C1Statement2;

}

if MyBehaviorMustComplete == 2
{

C2Statement1;
C2Statement2;

}

}

Again, a similar effect may be obtained by throwing events instead of using nested if statements. The compiler may also be operable to check more intelligently to reduce the number of tests that need to be executed.

One skilled in the art will notice that subsumption may also work the same way. Through the use of “if” statements, or by throwing events, the method that is subsumed is immediately terminated without actually killing the thread (the latter cause more overhead processing and more complexity). The above transformations show that the runtime level execution, discussed above for behaviors without continueWhen and completeWhen statements, may also be applied to behaviors with these statements.

Deadlock Detection

Runtime Level Aspects—Mobility of Agents

Communities

The description above has focused on agents that are all aware of each other. However, in one embodiment of the invention, an agent is only aware of the agents which are present in its “community.” For example, a community may be the same as an application. As such, all agents within an application may be aware of each other. One skilled in the art will note that ofterntimes an application that contains multiple communities is generally considered to be multiple applications.

In one embodiment, communities themselves can migrate. That is, a service can copy itself to another computer, and can start itself remotely. As a result, the community may make itself active on the other computer. Further, in such an embodiment an agent may migrate between replicated communities. In particular, an agent may generate a message that is sent to the other community, that contains its status. For example, such a message amy include the agent's type and the value of all of its sensors. One implementation may be to “dehydrate” the sensors of an agent into XML, and send this XML definition to the replicated community. There, a new agent may be created and all sensors of the agent may be set to the values received in the XML message (“hydrate”). The new agent may then send an acknowledgement back a message to the first agent, who may then choose to destroy itself. Alternatively, if the agent does not destroy itself, it has simply replicated itself.

In one embodiment, when an agent is newly created at any time and for any reason within a community (e.g. also through the new operator active on the data type), then the triggering conditions of all behaviors will be evaluated. Depending on the result, the behavior will activated or not. It is therefore quite possible that a behavior that was activated in a community, and that spawned the migration of its agent to a new community, is not immediately activated within the new community because its triggering condition is not met in the new community.

Grid Computing

Communities' ability to spawn copies of themselves (on other processors and machines) may allow them to take advantage of all authorized processing power that is available in a network. As such, a multi-agent interpretation of grid computing may result. For example, all nearby computers that are authorized for use may automatically and dynamically create a computing grid that executes a multi-agent system. Therefore, the multi-agent system may grow beyond the capabilities of a single computer for applications such as, for example, gaming, physics calculations, large banking calculations and other scaled-up applications.

Migration Between Similar Communities

A community is structurally identical if the definitions of all agents are identical, and neither community has additional agents relative to the other. The signature of a sensor is the name of the sensor, along with its type. Asu such, an agent A is considered similar to agent B, if it has the same name and if all of the sensors of agent A have a sensor with the same signature in agent B. Further, a community C1 is a similar to community C2, if some of the agents of C1 are similar to agents in C2. However, not all agents of C1 need to be similar to agents in C2.

In one embodiment, an agent can migrate between similar communities. In particular, an agent can generate a message that is sent to the other community, that contains its status. Foe example, its status may be composed of the name of the agent, and for every sensor of the agent, the signature of the sensor and its value. This information may be assembled in a data package (e.g. in XML definition) and sent to the other community with the request for replication. In the receiving community, the specified name of the agent is looked up. A check is performed to determine if the agent is similar. If the agent is not similar, then a message in that sense is sent back and no further actions are taken. If the agent is similar, a positive acknowledgement will be sent back to the sending community and a new agent instance is created in the receiving community. All the received values for the sensors are assigned to the agent. The creation of the agent, and the updates of the sensors, will send a number of events through the receiving community.

How an Agent Initiates Migration

Every community is a service or has an interface. For example, an interface may accept messages such as ACL (Agent Communication Language) messages or XML messages. In one embodiment, RIDL utilizes XML Web Services to establish communication between communities. Every community has a unique ID, usually represented by a URL.

An agent that wishes to migrate, needs to know the ID of the community to which it migrates. In one embodiment, two special functions are pre-defined methods of every agent: “int copyToCommunity(ID)” wherein the community with the specified ID is sent the data package described above requesting replication and the return code of the function contains an indication of success (0=copy successful); and “int migrateToCommunity(ID)” wherein a copyToCommunity is executed first and, upon success, the agent that was copied is killed. If an agent migrates itself, then it may be that it does not execute the line after the migrate instruction. If the migration is not successful, the next line may be executed, allowing diagnosis based on the return value by the agent. Once again, the syntax of the implementation may vary.

In one embodiment, the developer only needs to know the ID of the similar community and needs no knowledge of communication protocols, Web Services, ACL or any other technology. As such, whenever an agent is created, it has the ability to copy and migrate across similar communities, without any work by the developer. In one embodiment, this functionality is included in a method that is available on every agent. Alternatively, this functionality may be provided by a library that contains the functions “int copyToCommunity(AgentType, ID)” and “int migrateToCommunity(AgentType, ID).”

As such, migration is native to the language, either in a pre-defined method per agent, or in a library that is delivered together with the language. By changing the way a community starts , a developer can quite easily use the same source code to create “primary” and “secondary” communities wherein primary communities create their own agents in some sort of bootstrap and secondary communities are similar to primary communities, but contain no agents and are installed on remote terminals on the network waiting to receive agents that copy or migrate to them. In one embodiment, any primary community can be turned into a secondary community automatically by analyzing the constructors, and removing any statements that create the initial agents. In one application example, a game developer may provide a runtime engine that may be installed on PCs in a LAN to exploit the power of those PCs without having to write additional code.

Looking for Communities with Similar Agents

In one embodiment, an agent may obtain the ID of the community to which it wishes to migrate by using the infrastructure already present within the definitions of ACL and XML Web Services. In addition, an agent may look for all communities that are available on the computer or on the network or for communities that contain a similar agent. In general, it may be assumed that when an agent is interested if there are communities out there, it knows with which type of agent it wishes to speak. For example, a query may be provided to look for all communities in a neighborhood that contain a specified agent. The agent specified may be the agent itself, or it may be another agent. The lookup could be for similar agents as well as for structurally identical agents. Alternatively, a query may be provided to determine how many instances of an agent of the specified agent signature are present in a community.

In one embodiment, it may be desirable to allow a designer to use such functionality without having to know anything about the protocols behind it. For example, every agent may contain a predefined method of the following format:

communityCollection findCommunities(StructuralIdentical: boo1=false)

Wherein the communityCollection type is a collection of communityCollectionItem and the The communityCollectionItem is a structure with two parts: the ID of a collection, and the number of instances of the agent that is already present. The parameter “StructuralIndentical” may indicate whether to look for structural identical agents (true) or similar agents (false) where the default value is to look for similar agents. Again, this functionality may also be part of a library delivered with the language, where a function such as the following is available:

communityCollection findCommunities(AgentType: agent; StructuralIdentical: boo1=false)

One skilled in the art will note that an identical function may be obtained by changing the syntax in a number of ways.

Agents that Work Across Communities

In one embodiment, agents may automatically migrate to communities with fewer agents of a particular type or with more remaining CPU power. However, the “any” operators are community dependent, and will not pick up agents in other communities. For example, in a multi-user video game, a user has an army of 1,000 soldiers and each of these soldiers is represented by an agent with complex fighting and psychological behaviors. Further, another relatively powerful computer is part of the local network. If the user could use that machine in the game, the power may be available for a larger army and the user would have more power in the game. As such, a secondary community is available to receive additional soldiers. However, soldiers who are in the secondary community, and who respond to their environment through any operators, can no longer see the other agents that are in the primary community.

The various embodiments above provide a solution to this problem. The entire model is driven by the events that are created by sensors and behaviors. The state of an agent is largely stored in the values of the sensors. To have agents respond to each other across communities, stubs are needed to hold the sensors. As such, it may be desirable to have these stubs created automatically by the system while retaining the freedom to decide which agents can move out to other machines and which cannot.

To accomplish this goal, an agent may be annotated as “autoMigrate” with a keyword or attribute. For example:

void MyBehavior(): autoMigrate behavior

In one embodiment, for all autoMigrate behaviors the compiler may also create a second “stub” agent in the primary community that contains all of the sensors, but none of the behaviors. This stub agent will later be responsible to transfer sensors, as described below. In the secondary community, the full definition of the autoMigrate agent will be available, as well as stub agents for every agent that the autoMigrate agent relies upon.

When an autoMigrate agent is activated, it works like an ordinary agent and an “execution list” for the agent may be monitored. In one embodiment, an execution list is a list of behaviors that need to be executed and sorted on priority, as explained in the section on automatic priority detection above.

If the list of behaviors gets longer than a value ‘X,’ for example, an autoMigrate agent may be selected for migration wherein ‘X’ is a parameter that may be configured by the designer. Therefore, the event model and the resulting priority detection are utilized as a measure of processor activity, wherein an autoMigrate agent may stay on a computer as long as there is sufficient processing power.

To select an autoMigrate agent for migration, several criteria may be used. For example, the autoMigrate agent that relics on the smallest number of external sensors may be chosen. In this case, the sequence in which autoMigrate agents may be selected for migration can be determined at compile time. Another selection method may be to use the autoMigrate agent that is most frequently activated to reduce the workload of the resident computer. Yet another method may be to choose an autoMigrate agent that has the largest number of behaviors on the execution list or to choose a random autoMigrate agent or another method.

In one embodiment, in the primary community every time a sensor is updated in an agent that the autoMigrate agent relies on, the value update for the sensor is sent to the secondary community where it updates the stub for this agent. Likewise, in the secondary community every time a sensor of a migrated agent is updated, the related value of the sensor is sent back to the primary agent, where it updates the stub for the migrated agent. Because we are updating a sensor, this will recreate the events that existed in the secondary community. The compiler will ensure that the events created by the stub are identical to the events created by the original agent from the perspective of the using agent.

In one embodiment, the transmission of information between communities may be accomplished utilizing XML packages. For example, system defined behaviors could be added that respond to the events of the agents and send the information to the stub agents in the other community. Agents may either send the name of the stub to the other community (with known ID), or to a unique ID (pointer) directly to the stub's sensor.

At design time, a class may be specified to be autoMigrating. However, it is the individual instances that migrate. As such, every agent will decide for itself when it migrates. Hence, some instances of an autoMigrate agent may migrate, while other instances of the same agent class may not.

In one embodiment, there may be multiple secondary communities for a single primary community. On each migration, a community may be chosen similarly to the way described above in the section on looking for communities with similar agents, however, in this case the criteria will be looking for communities with agents that are structurally identical.

Security Issues for Migrating Agents

In one embodiment, security issues are resolved at the level of security for XML Web Services (or ACL level). For example, the security measures on the use of services should prevent agents from migrating to communities for which they do not have authorization.

Debug Level Aspects

Debug Behaviors

Multi-agent systems are very hard to debug, because they have so many parallel behaviors. Runtime errors can be generated by racing conditions, and co-occurrences of events that are extremely hard to recreate. “Stepping” through code rarely makes sense, because the side effects make the recreation of the concurrent nature of the system incomplete. Traditional debugging methods break down when debugging across agents. Therefore, an agent designer should ensure that agents are as robust as possible to external errors.

As such, the features outlined above may be expolited for the benefit of the designer by reasoning in terms of agents, behaviors and triggering conditions rather than in terms of, for example, methods and sequential code.

In one embodiment, a keyword or attribute may indicate that a behavior is a “debug” behavior, such as:

void MyBehavior( ) : debug behavior
when TrigCondWhen
if TrigCondIf
{

// statements

}

In such an embodiment, debug behaviors may be treated different from ordinary behaviors. For example, debug behaviors may be compiled only in a “debug” mode. In a “release” mode, these behaviors may be automatically removed. In another example, debug behaviors may have the highest priority. In one embodiment, a designer may minimize the statements in the body of debug behaviors wherein such a behavior has an empty body so only the triggering of the behavior is monitored. In another example, a debug behavior may not have continueWhen or completeWhen statements and may not be subsumed or resumed. In general, the debug behavior would not participate in the activities of the agent system. It would merely observe (and sometimes log) activities.

In another example, in debug mode, every behavior may contain logic to enable a “freeze” of the system. A freeze would stop all behaviors to allow for the analsis of a “snapshot” of the dynamical system. In another example, a debug behavior may run in “zero execution time,” wherein when a debug behavior is activated it freezes the system and then executes the body while everything remains frozen. The system is defrosted when the debug behavior completes. This allows the debug behavior to run checks and/or to update logs accordingly at specific points in the runtime.

Handling Exceptions

Exceptions include illegal operations that are executed at runtime. Such actions include the use of a null pointer, division by zero, and many other issues. These problems can occur both in the triggering condition evaluation and when executing the body.

In traditional languages, an error event is thrown that is caught at the end of the behavior. If the event is not caught, then the event is propagated outward until ultimately the entire system may crash. According to the invention, in one embodiment, a pre-defined scalar property “exception” may be associated with a behavior. Like the subsumed property, the exception property is a true sensor. When it is changed, it will throw events. For example, a designer may use a completeWhen statement to catch exceptions as they occur, and handle them. In one embodiment, if a behavior doesn't handle its exception, the behavior completes immediately. As such, the exception is not propagated and the system continues to work.

Since an exception may be a true sensor, any other behavior in the agent can respond to it. Therefore, another behavior in the agent may be dedicated to handling exceptions that occur in the agent.

Matrix Analyzer

In one embodiment, a “matrix analyzer” may monitor agents as they are executing. For example, like an analyzer in electronics, it may continuously show the values of all relevant parameters and present the data in various viewing formats.

For example, one view may show the list of communities found on the computer that are in debug mode (otherwise the matrix analyzer may not see them). Another view may show a single agent, with all of its sensors and behaviors. For example, for every sensor a value may be shown. For behaviors, the status of the code may be shown in colors, for example: black may mean the code is not currently active; green may mean the code is executing; orange may mean the code is waiting for execution; and red may mean something went wrong with the code during execution.

Another view may represent every agent as a single block or dot, wherein a color may indicate the status of the agent, for example: if something went wrong with any part of the code of the agent during execution, the agent may be red; if the agent isn't red and any behavior is waiting for execution, the agent may be orange; if the agent isn't red or orange, and any behavior is active, the agent may be green; and for “none of the above” conditions, the agent may be black. In one embodiment, this view may be represented as a matrix. For example, a screen of 1600×1200 pixels may show the activity of up to 1.92 million agents. Further, a particular pixel may be highlighted to allow for selecting a secondary view for a particular agent which, for example, may allow for more detailed analysis.

IDE Level Aspects

Agent View

In another embodiment, a visual agent designer may be defined to visually monitor agents. As such, there may be a number of views in such an visual modeler. For example, in one view a developer may see the agent in a way similar to UML. Instead of a single indicator before the variable or method in object oriented (OO) modeling, there may be two indicators, wherein the first is the same as with OO for indicating if the method, behavior, variable or sensor is private, public or friend and the second indicator shows whether it is an method or a behavior, and if it is a variable or a sensor. The second indicator essentially indicates if it is an agent concept (sensor or behavior) or an object concept (variable or method).

Behavior View

In the behavior view, the sensors and behaviors are shown outside of the agent they belong to. They are annotated by the name of the agent, but sensors and behaviors of the same agent do not need to be shown in the same neighborhood. Rather, the behaviors and sensors are spread out according to dependency, with the leave sensors and behaviors shown at the bottom (or at the top, or from left to right, or from right to left, according to the preferences of the user). In one embodiment, the sensors and behaviors are connected together with arrows, that show the dependency of between the items.

Dependency View

Based on the concepts of RIDL, a graph of dependencies can be defined. In one embodiment, this graph may be visualized in alternative ways. For example, the agents may be shown to the user (as in the agent view) and arrows may be drawn between the agents to show the dependencies. (One skilled in the art will notice that the exact priority may vary at runtime and cannot be shown statically.) Alternatively, the agents may be shown in behavior view, and arrows may again be drawn between the behaviors and sensors to show the dependencies.

Community View

In another embodiment, similar to the debug level aspects above, a community view may show the agents at runtime.

Learning Agents: Neural Agents—Aspects

In artificial neural networks (ANNs), neurons are mathematical formulas. They provide a number that represents their triggering value. Thresholds are often used to create only 0 or 1 as a triggering value. The formula in the neuron is based on a value often calculated as the sum of all nodes at a lower level, where each node is multiplied by a dedicated multiplication value. In the case of discrete ANNs, the weight must be between 0 and 1. By changing the individual weights, and by putting the neurons on layers, the system can learn to process complex data (such as identifying objects on images) simply through teaching.

In RIDL, the concept of a neural network may be used with slight modifications. In one embodiment, a neuron is represented by an agent. Its triggering value is a sensor and it has a behavior that responds to events from triggering values in a lower layer to recalculate its triggering value. The net result is that using the concepts of ANNs, RIDL software can learn very complex tasks without programming the solution (hence through training).

To create layers of agents, various principles may be utlized. For example, inheritance may be used to put all agents of a single layer under a single class name. Alternatively, every agent may have a number of the layer it is in, and this number can be one of the conditions checked in.

In one aspect, there is no “for all” construct in RIDL. Generally, it is impossible to visit all agents, because agents can be created or destroyed in the middle of such an action. Therefore, it is up to the agent itself to keep a list of agents it is connected to. Such a list may be traversed. For example, the list may be kept up to date by using “any” operators (e.g., if any agent exists within the layer I'm monitoring, for which hold that it is not in my list, then add it to the list).

Self-Writing Learning Agents: Genetic Evolution of Software—Aspects

Introduction

Simply put, genetic programming works on two principles: mutations make small random changes; cross-over takes to parents, and creates a single child by taking some parts of one parent, and some parts of the other parent.

Based on various application dependent parameters, the success factor of an agent can be determined. Most successful agents are allowed to “breed,” and using the two principles above, offspring are created. Variations exist, where a number of parents move to the next generation without change if they are extremely successful. The new generation is again measured for its success, and the new generation can again breed to create yet another generation. In general, for every generation the previous generation dies, although life expectancy of an agent may sometimes be multiple generations. As seen, genetic programming provides a way to allow software to evolve automatically to more efficient software.

Triggering Conditions as Basis for DNA Mutations

Behavior-Based Multi-Agent Systems, as described above, may be utilized for genetic programming. They provide a distinction between agents, and within agents behaviors form discrete blocks of functionality. This provides information which can guide mutation and cross-over operators to be more efficient than in blind source code modification.

In one embodiment, genetic programming assumes a large number of agent classes, and only one instance of each agent class. Hence, every agent is an individual and unique. When applying mutation or cross-over, unless otherwise stated, the body of one of the parents is utilized. The initial population of agents either contains behaviors with bodies that contain learning code (e.g. neural agents), or contains a lot of behaviors that take all sorts of small actions.

In one embodiment, the mutation operator works on one behavior of one agent. In one aspect, a number of mutation operators are defined, which work randomly over the population with an application-specific frequency, for example: (a) the name of a sensor that occurs in the behavior (usually in the triggering condition) is replaced by another existing name of a sensor. This replacement is done consistently, hence all occurrences are replaced to keep the logic of the software intact. Sensors can only be replaced by sensors of the same type. (b) The name of a behavior that occurs in the behavior in the triggering condition is replaced by another existing name of a behavior. (c) If a sensor is mentioned in the when part of the triggering condition, wait for a different event of the same sensor. Hence, a “sensor.updates” can be changed in either “sensor.changes” or “sensor.event.” (d) If a behavior is mentioned in the when part of the triggering condition, wait for a different event of the same behavior. Hence, a “behavior.activates” can be changed in either “behavior.completes,” or “behavior.event,” amongst others. (e) An event of the “when” part of the triggering condition can be dropped. (f) A condition of the “if” part of the triggering condition can be dropped. (g) An additional condition on any sensor already in the “when” part of the triggering condition can be added. (h) An additional event of an existing behavior or sensor can be added to the “when” part of the triggering condition. (i) A new sensor can be created in the agent, and the sensor is added to the when condition of the behavior. The updates to this sensor can come from the first specified mutation. The sensor is public or private depending on some probability.

Agent-level Cross-over

In one embodiment, a new agent may be constructed from two agents by, for example, taking a number of behaviors from one agent, and a number of behaviors from the other agent. These behaviors are brought together into a new agent. All the local sensors of both behaviors are copied to the new agent, except for the local sensors that are not used in any of the behaviors.

Basic Behavior-level Cross-over

This cross-over works with two behaviors. A new behavior can be created by merging partial copies of the triggering conditions of both behaviors into a new triggering condition. In one embodiment, the body of the new behavior is taken from one of both parents. The code inside the body is not touched, leaving the algorithms intact. If the copied parent has a “completeWhen” clause, then the clause may be copied identically. This ensures that the error handling associated with the algorithm is retained. Mutation on sensor names also applies to completeWhen clauses.

Sequential Behavior-level Cross-over

Another cross-over operator can make the two parents sequential. In one embodiment, this cross-over operator takes one parent, and at the end of the body of that parent, it puts a “continueWhen” statement with the triggering condition of the second parent. After that, it adds the body of the second parent. All “completeWhen” clauses of both parents are then appended.

Sequential Behavior-level Mutation

When a behavior has “continueWhen” statements, the code starting from the start of the body, or starting from a “continueWhen” statement, until the next “continueWhen” statement, or until the end of the body, is deleted.

Other operators can be used. The key point is that the triggering conditions and the syntax of RIDL allow an algorithm to define clear points where it can safely paste code together, without breaking the software from a syntactical and semantical level.

Extended Communities in Action

Genetic programming of multi-agent systems is made possible using the concept of similar communities.

In one embodiment, a genetic program has access to its own source code, because the developer supplied a representation of the source code to the genetic program. The genetic program makes changes to the source code, and recompiles the code. While doing so, it is useful for the genetic program to make use of inheritance.

After compilation, the new program is started and as a result, a new community is created. This community is normally similar to the original community. Because inheritance was used, the agent classes of the old community are largely intact, but new offspring has been created.

Next, all agents are made to migrate to the new community. After this has happened, the old community is destroyed. The net result is that our agents are still the same, but are now in an environment where they need to compete with their offspring.

Agent File System Aspects

When a file system is based on a database, as is the case, for example, in a current version of Microsoft® Windows, then the agent-oriented database principles can be used to assign behaviors to files. For instance, a file may monitor itself and decide it needs to backup itself, or repair itself, or notify the user of some condition, or be in other ways self-managing. This would advantageously take the burden of PC maintenance away from the user.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention.

1. A computer-readable medium having computer-executable components, comprising:
at least one agent having at least one sensor component including a goal or change method component and at least one behavior component;
wherein the at least one sensor component generates at least one event based at least in part on at least one generated value from the goal or change method component, and the at least one behavior component determines whether to activate a thread of execution based at least in part on the at least one generated event from the at least one sensor component.

2. The computer-readable medium of claim 1, wherein the at least one behavior component determines whether to record the at least one generated event.

3. The computer-readable medium of claim 1, wherein the at least one event is one of a changes or updates event.

4. The computer-readable medium of claim 1, wherein the at least one behavior component is external to the agent of the at least one event generating sensor component.

5. The computer-readable medium of claim 1, wherein the activation of the at least one behavior component includes generating at least one call.

6. The computer-readable medium of claim 5, wherein the at least one sensor component may be activated by its goal or change method component to generate at least one event based at least in part on the at least one call.

7. The computer-readable medium of claim 6, wherein the at least one sensor component is included in an agent external to the agent of the at least one call generating behavior component.

8. The computer-readable medium of claim 1, wherein a behavior component may subsume or resume at least one other behavior component or agent based at least in part on the at least one generated event from the at least one sensor component.

9. The computer-readable medium of claim 1, wherein the at least one behavior component generates a status event upon the activation of a thread of execution, the status event being receivable by at least one other behavior component.

10. The computer-readable medium of claim 1, wherein the at least one behavior component generates a status event upon the completion of a thread of execution, the status event being receivable by at least one other behavior component.

11. The computer-readable medium of claim 1, wherein the at least one behavior component determines whether to activate a thread of execution based on an independent triggering condition.

12. The computer-readable medium of claim 11, wherein the independent triggering condition may further determine a priority status for the activation of a particular thread of execution, and wherein a plurality of threads of execution may be performed sequentially based on their priority status for activation.

13. The computer readble medium of claim 12, wherein at least one of a ContinueWhen, resumeWhen and complete When statement within or outside the at least one behavior component is operable to synchronize threads of execution based on their priority status for activation.

14. The computer-readable medium of claim 11, wherein the independent triggering condition includes at least one when statement and at least one if statement, wherein the when statement indicates events to which the independent triggering condition responds to become active and the if statement is based on predetermined filtering values.

15. The computer-readable medium of claim 11, wherein the independent triggering condition requires a plurality of generated events to become active.

16. The computer-readable medium of claim 11, wherein the independent triggering condition is based on the local perception of the at least one behavior component.

17. The computer-readable medium of claim 14, wherein the at least one behavior component activates a thread of execution for an active independent triggering condition before the independent triggering condition becomes active again.

18. The computer-readable medium of claim 1, wherein the at least one behavior and sensor components are defined at least one keyword, wherein the at least one keyword indicates at least one of a particular agent, at least one behavior or sensor and a particular event for activating an independent triggering condition.

19. The computer-readable medium of claim 18, wherein the at least one keyword is operable to indicate any of a behavior or sensor component, agent or event unknown to the at least one agent.

20. The computer-readable medium of claim 18, wherein the at least one keyword is operable to indicate a predetermined agent class.

21. The computer-readable medium of claim 20, wherein the at least one keyword may indicate a particular agent within a predetermined agent class.

22. The computer-readable medium of claim 18, wherein the at least one keyword is operable to indicate when a particular behavior or sensor may be activated.

23. The computer-readable medium of claim 1, wherein the at least one agent may generate an event.

24. A computer program embodied on a computer-readable medium for enabling a behavior based multi-agent computing system, comprising:
a code segment for receiving a request; and
an execution framework comprising:
a plurality of agents having at least one sensor component, including at least one goal or change method component, and at least one normal, exhaustive or redundant behavior component;
wherein the at least one goal or change method component generates at least one value, the at least one sensor component generates at least one event based at least in part on the at least one generated value from the at least one goal or change method component, and the at least one behavior component determines whether to activate a thread of execution based at least in part on at least one generated event from the at least one sensor component.

25. The computer program embodied on a computer-readable medium for enabling a behavior based multi-agent computing system of claim 24, wherein the request is received from at least one agent.

26. The computer program embodied on a computer-readable medium for enabling a behavior based multi-agent computing system of claim 24, wherein the execution framework is layered over an object-oriented language construct to become an agent-oriented language construct, wherein objects and agents are inter changeable components within the agent-oriented language construct.

27. The computer program embodied on a computer-readable medium for enabling a behavior based multi-agent computing system of claim 26, wherein the agent-oriented language construct comprises an object-oriented-based language construct.

28. The computer program embodied on a computer-readable medium for enabling a behavior based multi-agent computing system of claim 26, wherein the agents form communites of agents being able to replicate.

29. The computer program embodied on a computer-readable medium for enabling a behavior based multi-agent computing system of claim 28, wherein the agents comprise a community of agents that are able to migrate between replicated communities.

30. The computer program embodied on a computer-readable medium for enabling a behavior based multi-agent computing system of claim 29, wherein an agent may migrate between communities through knowledge of a target community identification parameter.

31. The computer program embodied on a computer-readable medium for enabling a behavior based multi-agent computing system of claim 29, wherein an agent may search for a target community.

32. The computer program embodied on a computer-readable medium for enabling a behavior based multi-agent computing system of claim 26, wherein the layered system allows through agent communities spawning themselves to work in grid computing.

33. The computer program embodied on a computer-readable medium for enabling a behavior based multi-agent computing system of claim 26, wherein an agent may be active across communities through the use of at least one stub, wherein a stub may hold at least one sensor and are automatically generated.

34. The computer program embodied on a computer-readable medium for enabling a behavior based multi-agent computing system of claim 26, wherein the agents become a part of the namespaces that may be brought together to achieve a service.

35. The computer program embodied on a computer-readable medium for enabling a behavior based multi-agent computing system of claim 26, wherein a service may be indicated by a keyword or by an attribute that annotates the namespace.

36. The computer program embodied on a computer-readable medium for enabling a behavior based multi-agent computing system of claim 26, wherein at least one agent is operable to represent a neuron of a neural network, the at least one agent having at least one triggering value as the at least one sensor, and the at least one behavior component is operable to respond to at least one event from at least one triggering value in at least one lower layer.

37. The computer program embodied on a computer-readable medium for enabling a behavior based multi-agent computing system of claim 26, wherein atleast one agent utilizes at least one mutation or cross-over operator in the at least one behavior to implement at least one self-writing learning agent, thereby allowing the computer program to evolve automatically.

38. The computer program embodied on a computer-readable medium for enabling a behavior based multi-agent computing system of claim 26, wherein at least one behavior is assigned to at least one file to manage itself.

39. An agent-oriented database, comprising:
a plurality of fields including at least one agent;
the at least one agent having at least one sensor component including a goal or method change component;
wherein the at least one sensor component is operable to generate at least one event based at least in part on at least one generated value from the goal or method change component.

40. The database of claim 39, wherein the at least one agent includes a behavior component.
